(19) United States
(12) Patent Application Publication
(10) Pub. No.: US 2006/0092775 A1
(43) Pub. Date: May 4, 2006

(54) Content receiving apparatus and method

(75) Inventors: Koji Asai, Amagasaki city (JP); Tomohiko Kitamura, Hirakata city (JP); Toshiroh Nishio, Hirakata city (JP)

Correspondence Address: WENDEROTH, LIND & PONACK L.L.P., 2033 K. STREET, NW, SUITE 800, WASHINGTON, DC, 20006, US

(73) Assignee: Matsushita Electric Industry Co., Ltd.

(21) Appl. No.: 11/260,172

(22) Filed: Oct. 28, 2005

(30) Foreign Application Priority Data
Nov. 1, 2004 (JP) 2004-317861

(51) Int. Cl. G11B 17/22

(52) U.S. Cl. 369/30.32

(57) ABSTRACT

Technology is disclosed that allows a viewer to estimate the value of unknown content, and pay a fee relative to the estimated value. A cost corresponding to the value of each section is output for each of a plurality of sections that compose the received content. The recipient estimates the value of each section by referencing the cost of each section. Accordingly, the balance between the value and price of the section viewed on a trial basis does not produce a situation markedly different from that anticipated by the recipient, thus preventing dissatisfaction relating to the cost of the section viewed on a trial basis. A benefit is that, since the recipient views the section on a trial basis while having anticipated the value of the section, the recipient is more inclined to trial view unknown content, and the recipient can be expected to view more content by the content producer.

### BACKGROUND OF THE INVENTION

1. Field of the Invention

The present invention relates to technology for charging a fee for electronically distributed content.

2. Background Information

Various content has come to be electronically distributed in recent years in conjunction with broadcasting diversification and the development of communication systems. A portion of this content is electronically distributed for a fee. There are various methods of charging for this content. A charging method used in broadcasting, for example, provides that recipients purchase the right to view specific channels by paying a fixed fee each month. According to this method, the viewer freely watches programs broadcast on the channels for which viewing rights have been purchased in monthly units. Another charging scheme provides that a recipient pays an appropriate fee for desired content each time he or she wants to see the content.

Japanese Laid-Open Patent Publication No. 2002-44643 discloses technology that allows a recipient to purchase a portion, as well as the entirety, of a broadcast program. Therefore, in this reference, time information is obtained from MPEG data, and a fee is calculated based on the acquired time information. In this way it is possible for a broadcasting station to charge, for example, only for the events actually watched by the viewer from amongst all events in a sports tournament. It is also possible for a broadcasting station to charge only for the portion of a program actually viewed, such as for example when a viewer has only watched the beginning of a certain program.

In the fee charging methods disclosed in the conventional art, however, a viewer sees the content only after payment has been completed prior to viewing the content. This means that a viewer must decide whether or not to pay the fee for the content while being unable to verify the nature of the content, even when the viewer has already received the unknown content. Finally, since the nature of the received content is unclear to the viewer, the viewer hesitates to pay since she may find the content uninteresting, and therefore the recipient seldom watches the content.

Japanese Laid-Open Patent Publication No. 2002-44643 has certain effects with respect to charging for actually viewed content, and with respect to a viewer paying without deciding whether or not to pay for unknown content. However, there may be differences in the value of the content depending on portions of the content. In programs and films, for example, a climax ranging from the middle of the program to the end of the program may have more interest for the viewer than the introductory portion, and therefore may be considered to have a higher value. In the technology disclosed in Japanese Laid-Open Patent Publication No. 2002-44643, a viewer must pay a fee corresponding to the viewing time even when the viewer watches the beginning portion of a program but stops viewing because the content does not seem to be interesting. In this case there is a residual dissatisfaction as a result of the charge incurred when the viewer viewed uninteresting content on a trial basis.

In view of the above, there exists a need for technology that estimates the value of unknown content, and charges a fee in accordance with the estimated value. This invention addresses this need in the prior art as well as other needs, which will become apparent to those skilled in the art from this disclosure.

### SUMMARY OF THE INVENTION

The previously described problems are resolved by providing, in a first aspect of the present invention, a content receiving apparatus provided with the unit described below.
A receiving unit configured to receiving content having a plurality of sections, and charge information corresponding to the content;
a calculating unit configured to calculating the cost of each of the plurality of sections based on the charge information received by the receiving unit;
an output unit configured to associating the cost of each section calculated by the calculating unit with each section and outputting the same; and
a selection receiving unit configured to receiving a selection of at least one section.

The recipient may select a section for trial viewing after confirming beforehand the cost of each section included in the content. For example, a recipient may freely select to watch a high value section for a high fee, or to watch a low value section for a low fee. Furthermore, a recipient may also decide whether or not to continue viewing all the content after watching the introductory section. This is premised on the cost of a section being proportional to the value of the section as content. Therefore, viewer dissatisfaction after viewing can be prevented relative to the balance between the cost and value of the section viewed on a trial basis.

More specifically, it is possible to prevent the dissatisfaction that arises when an already purchased section is viewed and is not as interesting as anticipated. Thus, when a cost is specified for each section included in the content beforehand, and a section is selected that is inexpensive compared to another section, the recipient can surmise that that section may not be interesting.

A second aspect of the present invention provides the content receiving apparatus in the first aspect, wherein the charge information received by the receiving unit includes the unit value of each subsection contained in at least one section of the plurality of sections, and subsection identifiers for identifying each subsection contained in each section. In this apparatus, the calculating unit determines the number of subsection contained in each section based on the subsection identifiers, and calculates the cost of each section based on the determined number of subsections and the unit value of each subsection.

A subsection may be, for example, a frame. If the range of the frames of a section and the unit value of the frames are included in the charge information, the unit value of each section can be calculated by multiplying the unit value of the frames by the number of frames contained in the section. For example, serial numbers can be provided for the frames as a frame ID, such as “F001”, “F002” and the like. When a certain section A is composed of 100 frames having frame IDs “F001” through “F100” and the unit value of each frame is 2 yen, the cost of the section A is 200 yen. In this way a detailed charging system corresponding to the content can be realized by setting a unit value for each subsection representing a frame.

A third aspect of the present invention provides the content receiving apparatus according to the second aspect, wherein the charge information received by the receiving unit further includes additional information relating to each of the plurality of subsections. In this apparatus, the output unit associates the additional information with each section and the cost of each section, and outputs the same.

A recipient can easily estimate the value of each portion by referencing the added information. Text data directly expressing content, such as “intro”, “rising action”, “climax”, “ending” and the like are examples of added information. In this example, the recipient estimates the “climax” portion as the content of highest value. Conversely, the recipient may imagine the “intro” portion and “ending” portion as low value content.

A fourth aspect of the present invention provides the content receiving apparatus of the first aspect, wherein the output unit associates a percentage of the time length of each section in the content with each section as well as the cost of each section, and outputs same.

In this way the recipient can determine whether or the cost corresponds to the length of the section before trial viewing the section. Accordingly, it is possible to prevent the recipient from being disappointed as a result of the trial viewing, as the selected section, albeit interesting, was short compared to the fee paid. The time length of the section relative to the entire content can be determined, for example, by the number of subsections of each section relative to the number of subsections contained in the entire content.

A fifth aspect of the present invention provides the content receiving apparatus of the first aspect, and further includes a playback/output unit configured to playing back/outputting a selected section. In this apparatus, the selection receiving unit determines whether or not the playback/output of all sections contained in the content has ended or will end prior to the end or after the end of the playback/output of the section selected by the playback/output unit. Moreover, the selection receiving unit receives the selection of at least one remaining section in accordance with the determination result.

The recipient can select another section when the playback/output of the selected section has ended or will end. The recipient can also pay the fee for the content in graduated installments. Therefore, there are fewer instances of a viewer not watching the entire content compared to the mode of paying a fee for the entire content from the start, and the mode of paying a fee for the remaining portion after having viewed part of the content. Since the fee for the content may be paid in graduated installments, the recipient has the satisfaction of paying only for that portion of the content that is really of interest.

A sixth invention provides, in the first invention, a content receiving apparatus further including the unit described below.
a communication unit connected through a network to a charging device for executing a predetermined charging process for one or more portions of the content;
a charge requesting unit configured to sending a payment request for a selected section to the charging device, and receiving permission to obtain a selected section from the charging device in accordance with the request; and
a playback/output unit configured to playback/output the selected section based on the permission received by the charge requesting unit.

A section is played back/output after the fee-paying process for a selected section.

A seventh invention provides a content receiving method including the following steps.
a receiving step for receiving content having a plurality of sections, and charge information corresponding to the content;
a calculating step for calculating the cost of each of the plurality of sections based on the charge information received in the receiving step;
an outputting step for associating the cost of each section calculated in the calculating step with each section and outputting same; and
a selection receiving step for receiving a selection of at least one section.

The method of the present invention is performed by the apparatus described in the first invention, and provides an effect identical to that of the first invention.

An eighth invention provides a content receiving program for enabling a computer to function as the unit described below.
a receiving unit configured to receiving content having a plurality of sections, and charge information corresponding to the content;
a calculating unit configured to calculating the cost of each of the plurality of sections based on the charge information received by the receiving unit;
an output unit configured to associating the cost of each section calculated by the calculating unit with each section and outputting the same; and
a selection receiving unit configured to receiving a selection of at least one section.

The program of the present invention enables a computer to function as the apparatus described in the first invention, and provides an effect identical to the first invention.

A ninth invention provides a content receiving apparatus including the following unit.
a receiving unit configured to receiving content having a plurality of sections, and charge information corresponding to each section of the content;
an output unit configured to associating the cost of each section received by the receiving unit with each section and outputting the same; and
a selection receiving unit configured to receiving a selection of at least one section.

A content distributing apparatus, WWW server or the like stores a charge table that includes the unit value of each section contained in the content beforehand, such that the charge table can be downloaded to the content receiving apparatus separately from the content itself. In this case, it is unnecessary to calculate the cost of each section at the terminal itself if the content receiving apparatus can associate the cost of a received section to the section, and output same. Furthermore, viewer dissatisfaction after viewing can be prevented relative to the balance between the cost and value of the section viewed on a trial basis, similar to the first invention.

Using the present invention, the recipient estimates the value of unknown content by his or herself, and pays a content fee corresponding to the estimated value. Therefore, the advantages are that the recipient is easily convinced to pay the fee, and feels no dissatisfaction in paying the fee.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a structural diagram of the content distribution system including the content receiving apparatus of the first embodiment;

FIG. 2 is a conceptual drawing of the charge information stored in the content distributing device of FIG. 1;

FIG. 3 shows the structure of the extension data and user data included in the video sequence in an MPEG video stream;

FIG. 4 shows an example of the data format when the charge information is described in the extension data;

FIG. 5 (a) is a conceptual drawing of a temporary table generated by the charge information extractor of FIG. 1;

FIG. 5(b) is a conceptual drawing of a playback status table generated by the specification receiving unit of FIG. 1;

FIG. 6 shows the flow of the screen output by the content receiving apparatus;

FIG. 7 shows an another example of a selection screen display.

FIG. 8 shows an example of the flow of the processes executed by the content distribution system of FIG. 1;

FIG. 9 is a structural diagram of the content distribution system including the content receiving apparatus of a second embodiment; and

FIG. 10 is a conceptual drawing of the charge information stored in the charge table of FIG. 9.

### DETAILED DESCRIPTION OF THE PREFERRED EMBODIMENTS

Summary of the Invention

The content receiving apparatus of the present invention outputs a price corresponding to the value of each section, for each of a plurality of sections that compose the received content. The operator (hereinafter referred to as “recipient”) of the content receiving apparatus can estimate the value of each section by referencing the price of each section. For example, the recipient can anticipate that a relatively cheaper section may be rather uninteresting. Likewise, the recipient may anticipate that the highest priced section contains the best content. In this way the recipient selects a section for trial viewing while anticipating the value and cost of each section from the beginning. Accordingly, the balance between the value and price of the section viewed on a trial basis does not produce a situation markedly different from that anticipated by the recipient. Therefore, dissatisfaction regarding the price of the trial viewed section is prevented. An advantage is that, since the recipient views the section on a trial basis while having anticipated the value of the section, the recipient is more inclined to view unknown content on a trial basis. A further advantage is that the content distributor has more content viewed by an audience.

### First Embodiment

(1) General Structure

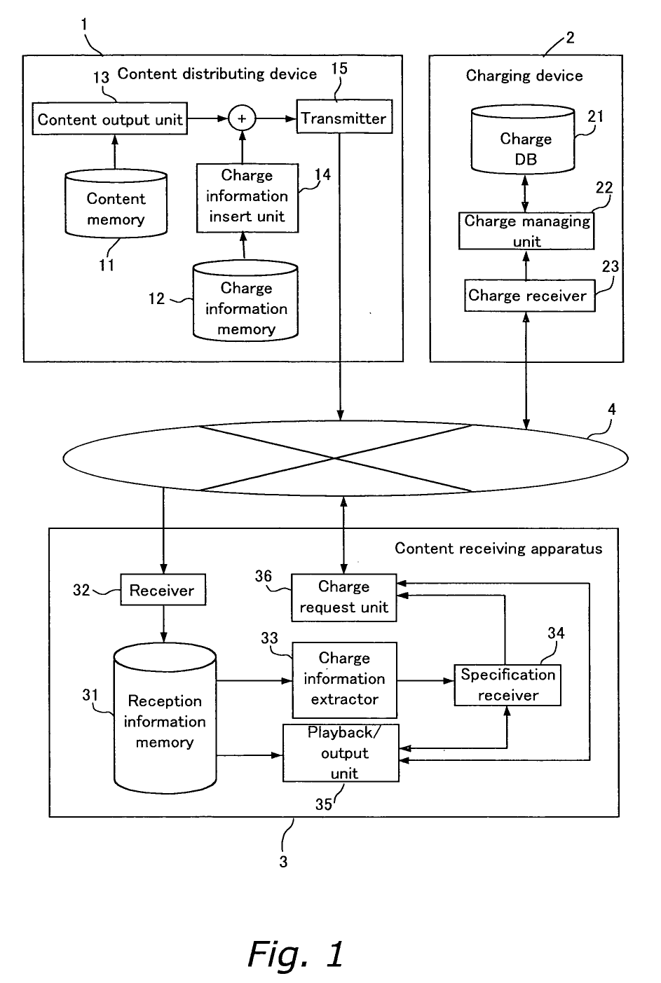

FIG. 1 is a structural diagram of the content distribution system including the content receiving apparatus of the first embodiment. The content distribution system includes a content distributing device 1, charging device 2, and content receiving apparatus 3. The content distributing device 1, charging device 2, and content receiving apparatus 3 are capable of communication over a network 4, such as the internet or the like. The content distributing device 1 transmits content and charge information to the content receiving apparatus 3. The charging device 2 transmits permission to obtain a portion or all of the content to the content receiving apparatus 3. The content receiving apparatus 3 outputs the cost of each section of the content, and receives the selection of at least one section from the recipient operating the content receiving apparatus 3. Although only one content receiving apparatus 3 is shown in the drawing, normally a plurality of content receiving apparatuses 3 are connected to a network 4. Furthermore, a plurality of content distributing devices 1 and charging devices 2 may be provided. Each device is described in greater detail below.

(2) Content Distributing Device

(2-1) Content Distributing Device Structure

The content distributing device 1 is provided with structural elements (a) through (e) described below.

(a) Content memory 11 stores content. The content is not specifically limited, and may be AV data, still image data, text data and the like. Furthermore, the file format is not specifically limited. For example, program data broadcast by digital broadcast is one example of AV data. The content is composed of a plurality of sections. Each section may be suitably set by the content producer based on the contained content. Each section includes at least one subsection. The subsection is not specifically limited, and may be a data unit composed of content data. For example, when the content includes video images, still images, and/or music data, frames may be used as the subsections. When the content is e-mail data, each e-mail may be used as a section and also a subsection. An e-mail header can include In the present embodiment, a situation is assumed in which each section of the content, that is, video data, includes a plurality of frames as subsections.

(b) The charge information memory 12 stores charge information for each content. The cost of each section contained in each content is defined by the charge information. The charge information is described in detail below.

(c) The content output unit 13 reads content from the content memory 11, and packetizes the data.

(d) The charge information insert unit 14 reads the charge information corresponding to the content to be transmitted from the charge information memory 12. Packets of charge information attached content are generated which describe the content and describe the read charge information. Examples of these descriptions are described in detail later.

(e) The transmitter 15 sends packets of charge information attached content to the content receiving apparatus 3 over a network.

(2-2) Charge Information

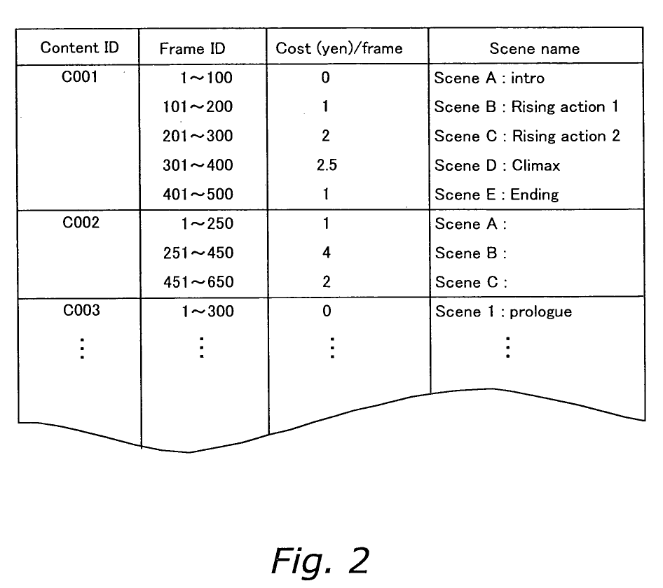

FIG. 2 is a conceptual drawing of the charge information stored in the content distributing device 1. The charge information is normally prepared by the content producer. In the present example, the charge information includes “content ID”, “frame ID”, “price (Yen)/frame”, and “scene name” in one code. These items are described below.

(a) Content ID is an identifier for identifying content.

(b) Frame ID describes the range of frame ID included in each section. The frame ID is an identifier for identifying the frame. For example, serial numbers allocated to the frames in the content may be used as the frame ID. The number of frames and the range of frames included in each section are defined by the “frame ID”.

(c) Price (Yen)/frame is the unit value of the frames belonging to each section. Although the unit value of frames belonging to the same section are identical in the present example, frames having different unit values also may belong to the same section.

(d) Scene name is the name given to a scene. “Scene name” is one kind of added information provided for each section, and is not necessarily mandatory. Associating added information such as “scene name” and the like with each section beforehand is advantageous in as much as the recipient can then easily select sections based on the added information. In the example of FIG. 2, the scene name of content ID “C001” contains information indicating the position of each section in the content, such as, “intro”, “rising action 1”, “rising action 2”, “climax”, “ending” and the like. For example, “intro” and “ending” indicate to the recipient that the sections are not high value, whereas “climax” indicates to the recipient the section has the greatest value. The recipient can select a section for trial viewing based not only on the cost, but also the scene name. The added information exemplified in “scene name” may differ depending on the content. In certain content, the information “intro” and “climax” need not be included in the scene name. In addition, information such as “prologue” and the like may be included in the scene name of other content. Added information, such as the producer of the content, may be appended to each section by the producer.

Furthermore, a charge information expiration time also may be included in the added information field of the “scene name” and the like in addition to information indicating the position of the section.

(2-3) Content Including Charge Information

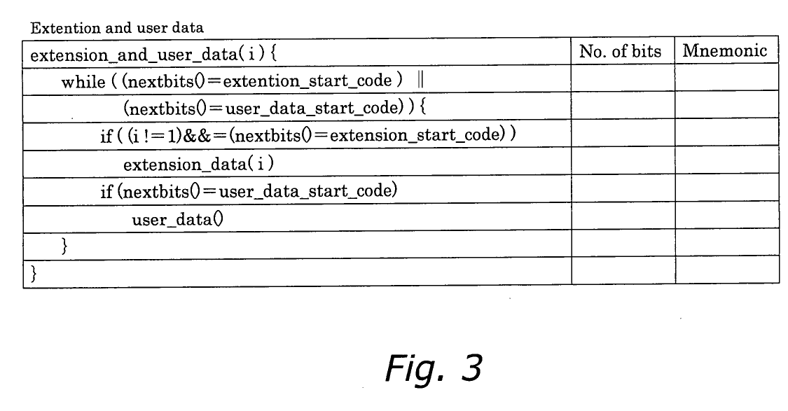

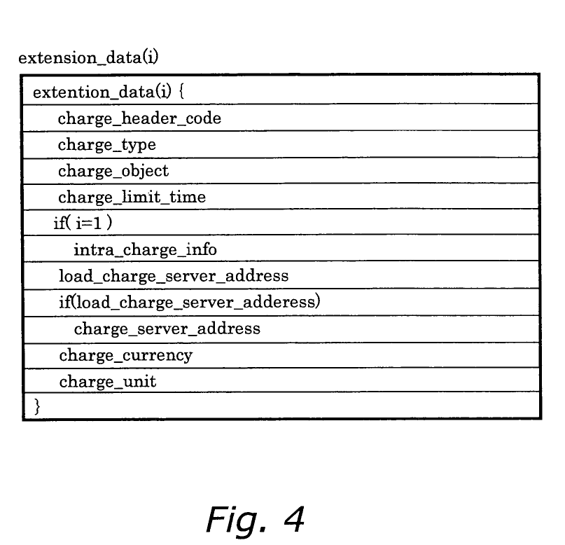

FIGS. 3 and 4 show examples of charge information inserted in the header of an MPEG video stream based on the charge information example shown in FIG. 2. FIG. 3 shows the structure of extension data and user data (extension_and_user_data (i)) included in the video sequence (video sequence ( )) of the MPEG video stream based on the ISO/IEC13818-2 standard. In this example, the charge information is described in extension data (extension_data(i)) in the header of the packet, however, the charge information may also be described in the data portion of the packet.

FIG. 4 shows an example of the data format when the charge information is described in the extension data (extension_data (i)). The extension data include the following items (a) through (i). The charge information insert unit 14 selects the information required to calculate the cost of a section on at least the content receiving apparatus 3 side from among the charge information shown in FIG. 2, and the selected information is described in the extension data.

(a) Charge_header_code represents the beginning of the charge information.

(b) Charge_type is a flag identifying whether there is a charge and various methods of charging. Methods of charging may be, for example, advanced payment by a pre-paid card, and later payment by a credit card or a cellular phone. Another method of charging may be a fixed charge based on contract or a charge depending on data amount and based on contract.

(c) Charge_object represents the effective range of the charge and the object of the charge. The charge_object is described based on the “frame ID” and “scene name” of the charge information (refer to FIG. 2). Specifically, the number and range of the frames belonging to a certain section are described by the frame ID. The added information of the section to which the charge_object frame belongs is described by the section name, for example, “scene D: climax” and the like.

(d) Charge_limit_time represents the expiration time of the charge. When, for example, the charge information of FIG. 2 includes an expiration time in the added information, such as “scene name” and the like, the charge_limit_time is described based on that information.

(e) Intra_charge_info describes information relating to the presence of charge information within the packet, and which header the charge information is embedded in.

(f) Load_charge_server_address indicates whether the charge device is the same computer as the content distributing device 1, and specifies another charge device when the flag is ON.

(g) Charge_server_address describes the address of the effective charge device when the “load_charge_server_address” is ON.

(h) Charge currency describes the monetary currency of the charge, for example Japanese Yen, dollars or the like. The charge_currency is described based on the “cost (Yen)/frame” of the charge information.

(i) Charge_unit describes the unit value of the frames in a range specified by the “charge_object”. The charge_unit is described based on the “cost (Yen)/frame” of the lower information.

FIGS. 3 and 4 show examples of data format of the charge information attached content. The data format of the charge information attached content may be suitably set in accordance with various conditions, such as the content data format, compression format, content transmission mode and the like.

(3) Charge Device

The charge device 2 is described below referring again to FIG. 1. The charge device 2 includes the following structural elements.

(a) Charge DB (database) 21 associates and stores in memory the recipient, the ID of the content viewed by the recipient, and the charges incurred by the recipient. The viewing day and time, and section name may also be stored.

(b) Charge managing unit 22 reads from and writes to the charge DB 21. Furthermore, a settlement process, such as a withdrawal from the recipient's bank account, also may be executed based on the information stored in the charge DB 21.

(c) Charge receiver 23 receives a charge request including a section selection from the content receiving apparatus, and sends permission to obtain the selected section. For example, including a description permitting viewing of a selected section of content protected by copyright may be included in the permission to obtain a section. In this way the content receiving apparatus 3 can playback sections which have been purchased.

(4) Content Receiving Apparatus

(4-1) Content Receiving Apparatus Structure

The content receiving apparatus 3 is described below referring again to FIG. 1. To facilitate understanding, the content receiving apparatus 3 is described by way of example of receiving charge information attached content by means of the packet structure shown in the examples of FIGS. 3 and 4. The content receiving apparatus 3 includes the following structural elements.

(a) Reception information memory 31 stores the charge information attached content.

(b) Receiver 32 (which corresponds to the receiving unit recited in the claims) receives the charge information attached content over the network 4, and stores the data in the reception information memory 31.

(c) Charge information extractor 33 (which corresponds to the calculation unit recited in the claims) extracts the charge information from the charge information attached content, and calculates the cost of each section that composes the received content based on the extracted charge information. Prior to the calculation, the charge information extractor 33 may also generate a temporary table representing the cost of each section based on the charge information.

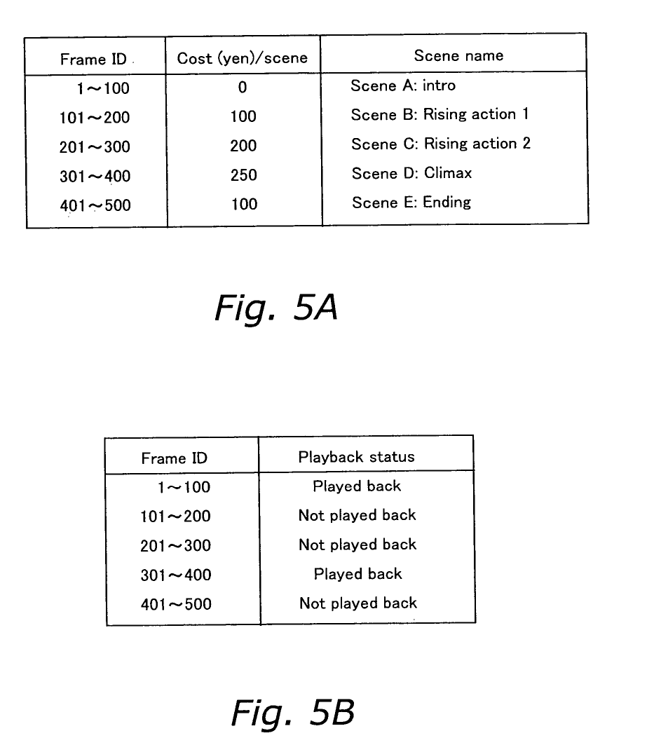

FIG. 5(a) is a conceptual drawing of a temporary table generated by the charge information extractor 33. This table includes “frame ID”, “cost (Yen)/scene”, and “scene name” in one record. The “frame ID” represents the number and range of frames belonging to each section. The number and range of frames can be extracted from the charge_object included in the received packet (refer to FIG. 4). The “cost (Yen)/scene” is the price of the section to which the corresponding frame ID belongs. The cost of the section is calculated by multiplying the number of frames determined from the charge_object, and the unit value of the frames described in the charge_unit in the received packet. The “scene name” is an example of the added information of the section. The “scene name” is extracted from the charge_object.

(d) Specification receiver 34 (which corresponds to the output unit and selection receiving unit recited in the claims) generates and outputs a selection screen showing the cost of each section based on the calculation result or temporary table of the charge information extractor 33. Furthermore, the specification receiver 34 receives one or more section selections from the recipient, and provides the frame IDs which compose the selected section to the charge information extractor 33 and a playback/output unit described below. The specification receiver 34 generates and manages a playback status table for each section. FIG. 5(b) is a conceptual drawing of a playback status table generated by the specification receiver 34. The specification receiver 34 updates the playback status table based on the section playback start notification from a playback/output unit described below. The playback status table of FIG. 5(b) shows a section composed of frame IDs 1 through 100, and a section composed of frame IDs 301 through 400, and indicates playback has started.

The specification receiver 34 receives further section selections when the playback of previous sections selected by the recipient has ended. Specifically, the specification receiver 34 determines whether or not the playback/output of all sections included in the content has ended or will end after or before the playback/output of the selected sections has ended. This determination is accomplished based on the playback status table. When the specification receiver 34 determines there is a section that has not been played back/output, at least one selection of a remaining section is received by the selection screen. The selection screen output by the specification receiver 34 is described in detail below.

(e) Playback/output unit 35 (which corresponds to the playback/output unit recited in the claims) obtains the frame IDs included in the selected section from the specification receiver 34, and reads and outputs the corresponding frame from the reception information memory 31. The output destination may be an output device such as a monitor and speaker connected to the content receiving apparatus 3, or may be a playback device connected to such output device.

(f) Charge request unit 36 (which corresponds to the communication unit and charge request unit recited in the claims) transmits a charge request to request payment for the selected section to the charging device 2 based on the notification of the frame IDs from the specification receiver 34. The charge request includes at least the content ID, total amount of unit value of the selected section, frame IDs specifying the frames included in the selected section, and a recipient identifier to identify the recipient. The day and time, and added information such as the scene name also may be included.

The charge request unit 36 specifies playback of the selected section to the playback unit 35 when permission to obtain the section is received from the charging device 2 in accordance with the charge request.

(4-2) Selection Screen

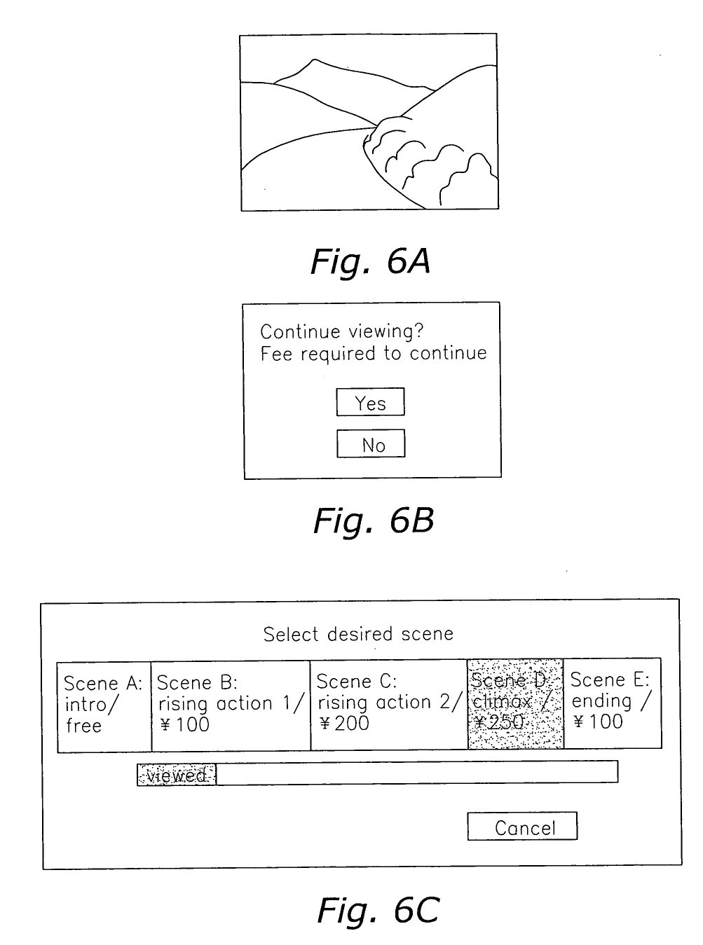

FIG. 6 shows the flow of the screen output by the content receiving apparatus 3. In this example, after the free “scene A: intro” is first played back/output without specification by the recipient based on the temporary table of FIG. 5(a), the recipient is asked whether she wants to select any section.

FIG. 5(a) is the playback/output screen of the “scene A: intro” section. FIG. 5(b) is an example of a confirmation screen asking the recipient whether or not she wants to select another section after “scene A: intro” has ended. The confirmation screen is output by the specification receiver 34 prior to the selection screen. When the “YES” button in the confirmation screen is pressed, the selection screen shown in the example of FIG. 5(c) is output. The output of the confirmation screen is not necessarily required.

Part (c) of this drawing shows an example of a selection screen output by the specification receiver 34. In this drawing, the scene name and cost of each section that composes the content is associated and indicated. The display sequence of each section is determined based on the frame ID sequence. The range of each section is determined proportional to the number of frames that compose each section. In this way the temporal length of each section can be visually indicated. Furthermore, the status of each section regarding whether or not it has already been played back is associated with each section and displayed.

The selection screen receives the selection of one or a plurality of sections. A selected plurality of sections may be continuous, or discontinuous. This drawing shows the “scene D: climax” scene has been selected. In the selection screen, a previously played back section may be reselected. In this case, since another fee payment is not required, the specification receiver 34 does not send notification of the frame ID corresponding to the selected scene to the charge request unit 36.

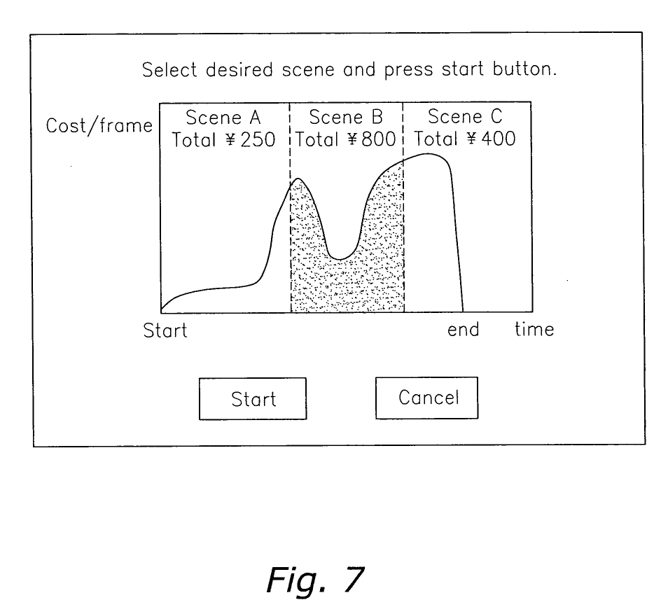

FIG. 7 shows an another example of a selection screen display. This selection screen shows a graph indicating the cost of each frame that composes the content, with the unit cost per frame on the vertical axis and the time on the horizontal axis. The content is composed of three sections, including scene A, scene B, and scene C. The cost of each section is displayed as an integral value of the graph of the appropriate section. This drawing shows the condition when scene B has been selected. In this condition, when the “start” button is pressed, the section is played back after the charging process has been executed for the selected section. In this display example, the change in the unit value of the frames that compose the content can be grasped visually.

(5) Processing Flow in the System

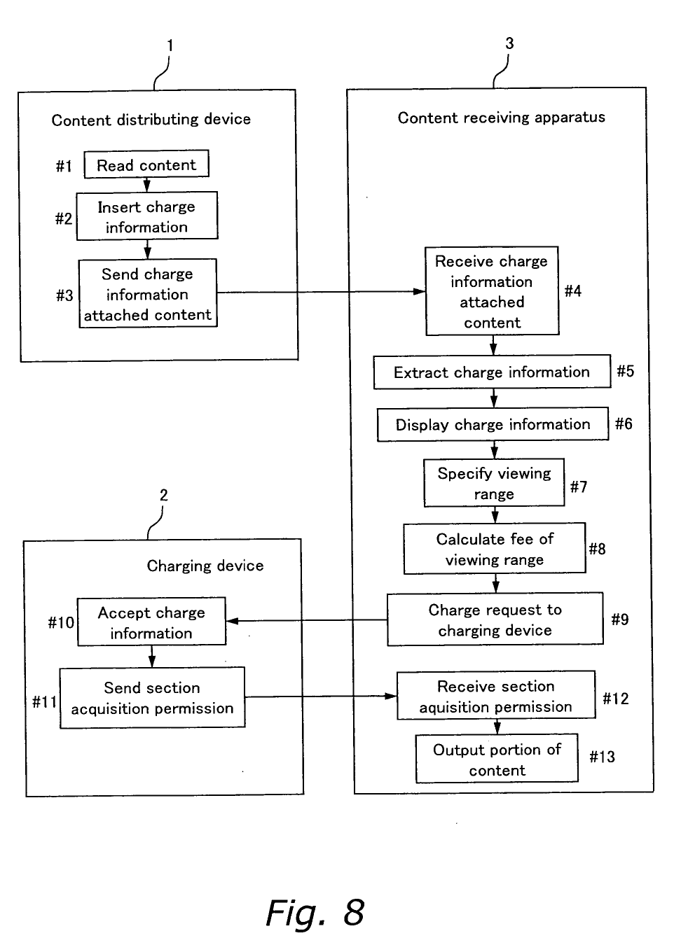

FIG. 8 shows an example of the flow of the processes executed by the content distribution system of the first embodiment.

First, the content distribution device 1 packetizes the content stored in the content memory 11 (#1). Then, the content distributing device 1 inserts the charge information stored in the charge information memory 12 in a portion, for example, the header, of the packet of the content (#2), and sends the packets of the charge information attached content to the content receiving apparatus 3 (#3).

When the packets of the charge information attached content are received (#4), the content receiving apparatus 3 extracts the charge information, and generates the previously mentioned temporary table by calculating the unit value of each section (#5). The extraction of charge information is performed after the reception has been completed for all content packets in the present embodiment. Next, the content receiving apparatus 3 generates and outputs a selection screen based on the temporary table or the calculated unit value of the section (#6), and receives the selection of one or a plurality of sections (#7). The content receiving apparatus 3 calculates the total of the unit values of the selected sections (#8), and sends a charge request to the charging device 2 (#9).

When the charge request is received from the content receiving apparatus 3 (#10), the charging device 2 updates the charge DB 21, and thereafter sends permission to obtain the sections to the content receiving apparatus 3 (#11).

When permission to obtain the sections is received from the charging device 2 (#12), the content receiving apparatus 3 starts playing back/outputting the frames included in the selected sections based on the permission (#13).

According to the aforesaid process, the recipient selects a portion of unknown content his or herself prior to paying the entire viewing fee, and is able to partially view the content by paying a fee only for the selected sections. Since the recipient can reference the structure of the content and cost of each section prior to selection, sections can be selected for trial viewing while estimating the value of each section based on the relative high and low values of each section. Accordingly, the recipient readily views unknown content with negligible dissatisfaction regarding the balance between the cost paid for trial viewing and the value of the sections viewed on a trial basis, and the recipient therefore can be expected to view more fee-based content.

### Second Embodiment

(1) General Structure

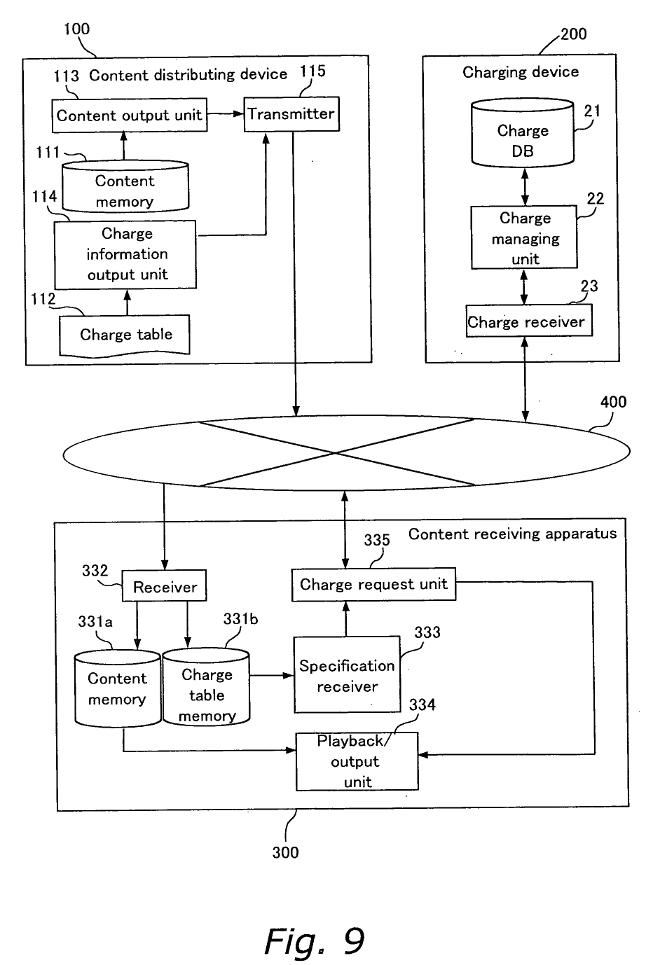

FIG. 9 is a structural diagram of the content distribution system including the content receiving apparatus of the second embodiment. The content distribution system includes a content distribution device 100, charging device 200, and content receiving apparatus 300. The content distribution device 100, charging device 200, and content receiving apparatus 300 are capable of communication over a network 400, such as the internet and the like. In this content distribution system, the content distributing device 100 transmits the content and the charge information separately. The charge information may be transmitted to the content receiving apparatus 300 from a computer terminal separate from the content distributing device 100, for example, from a WWW server over the internet. Since the elements of the charging device 200 have the same functions as in the first embodiment, there are labeled by the same reference numbers as in the first embodiment. Although only one content receiving apparatus 300 is shown in FIG. 9, normally a plurality of content receiving apparatuses 300 are connected to the network 400. Furthermore, a plurality of content distributing devices 100 and charging devices 200 may be provided. Each device is described in greater detail below.

(2) Content Distributing Device

The content distributing device 100 is provided with structural elements (a) through (e) described below.

(a) Content memory 111 stores content. The type of content, sections, and subsections are identical to the first embodiment.

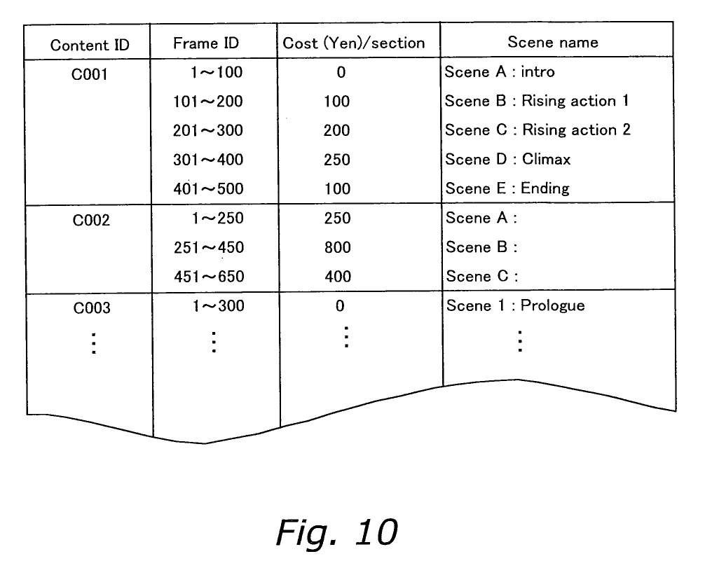

(b) Charge table 112 stores the charge information of each content. The cost of each section included in each content is defined by the charge information. FIG. 10 is a conceptual drawing of the charge information stored in the charge table 112. In this example, the charge table 112 includes the “content ID”, “frame ID”, “cost (Yen)/section”, and scene name” in one record. The “cost (Yen)/section” represents the unit value of each section. The “content ID”, “frame ID”, and “scene name” are identical to FIG. 2.

(c) Content output unit 113 reads and packetizes the content from the content memory 111.

(d) Charge information output unit 114 reads and packetizes the charge information from the charge table 112.

(e) Transmitter 115 sends the content packets and charge information packets separately to the content receiving apparatus 300 over the network 400.

(3) Content Receiving Apparatus

The content receiving apparatus 300 includes the following structural elements.

(a) Content memory 331a stores the content received from the content distributing device 100.

(b) Charge table memory 331b stores the charge information received from the content distributing device 100 in table format.

(c) Receiver 332 (equivalent to the receiving unit) receives the content and charge information over the network 400, and stores the data in the content memory 331a and the charge table memory 331b.

(d) Specification receiver 333 (equivalent to the output unit and selection receiving unit recited in the claims) generates and outputs a selection screen (refer to FIG. 6) indicating the cost of each section based on the charge information read from the charge table memory 331b. Since the information relating to unit value of each frame is not provided in the content receiving apparatus 300 in the present embodiment, the output of the selection screen shown in the example of FIG. 7 is limited. The aspect of notifying the playback/output unit 335 of the selected sections, the aspect of managing the playback status of each section, and the aspect of receiving a section reselection when all content are not played back/output, are identical to the first embodiment.

(e) Playback/output unit 334 (equivalent to the playback/output unit recited in the claims) obtains the frame IDs included in selected section, and reads and outputs the corresponding frames from the content memory 331a. The output destination may be an output device such as a monitor and speaker connected to the content receiving apparatus 300, or may be a playback device connected to such output device.

(f) Charge request unit 335 (equivalent to the communication unit and charge requesting unit) sends a charge request requesting payment for a selected section to the charging device 200 based on the notification of the frame ID from the specification receiver 333. The information included in the charge request is identical to the first embodiment. When permission to obtain the section is received from the charging device 200, the charge request unit 335 specifies playback of the selected section to the playback/output unit 334.

An advantage is that since output of the selection screen may be accomplished based on the charge table distributed from the content distributing device 100 in a content distribution system of the aforesaid structure, the calculation of the unit value of each section is not performed on the content receiving apparatus 300 side.

### Other Embodiments

(A) It is possible to stream the charge information attached content in the first embodiment. The content receiving apparatus 3 may prepare a temporary table while successively storing the content. The section of the content specifiable by the recipient may be initially limited to the first section, to advantageously reduce the waiting time until the playback of the first section of the content starts.

(B) The computer program for executing the previously described method on a computer, and a computer readable recording medium that records that program are included in the scope of the present invention. Examples of computer readable media include floppy disks, hard disks, CD-ROM, MO, DVD, DVD-ROM, DVD-RAM, BD (Blue-ray Disc), and semiconductor memory.

The computer program is not limited to being recorded on a recording medium, and may also be transferred over an electric communication line, wireless or wired communication line, a network such as the internet and the like.

The embodiments may be suitably combined.

### INDUSTRIAL APPLICABILITY

The present invention is applicable to content distribution services, such as digital broadcasting, and music distribution and the like.

This application claims priority to Japanese Patent Application No. 2004-317861. The entire disclosure of Japanese Patent Application No. 2004-317861 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A content receiving apparatus, comprising:
a receiving unit configured to receiving content having a plurality of sections, and charge information corresponding to the content;
a calculating unit configured to calculating the cost of each of the plurality of sections based on the charge information received by the receiving unit;
an output unit configured to associating the cost of each section calculated by the calculating unit with each section and outputting the same; and
a selection receiving unit configured to receiving a selection of at least one section.

2. The content receiving apparatus of claim 1, wherein the charge information received by the receiving unit includes the unit value of each subsection contained in at least one of the plurality of sections, and subsection identifiers for identifying each subsection contained in each section; and
the calculating unit determines the number of subsections contained in each section based on the subsection identifiers, and calculates the cost of each section based on the determined number of subsections and the unit value of each subsection.

3. The content receiving apparatus of claim 2, wherein the charge information received by the receiving unit further includes additional information relating to each of the plurality of subsections; and
the output unit associates the additional information with each section and the cost of each section, and outputs the same.

4. The content receiving apparatus of claim 1, wherein the output unit associates a percentage of the time length of each section in the content with each section as well as the cost of each section, and outputs the same.

5. The content receiving apparatus of claim 1, further comprising:
a playback/output unit configured to playback/output of a selected section; and
wherein the selection receiving unit determines whether or not the playback/output of all sections contained in the content has ended or will end before the end or after the end of the playback/output of the section selected by the playback/output unit, and receives the selection of at least one remaining section in accordance with the determination result.

6. The content receiving apparatus of claim 1, further comprising:
a communication unit connected through a network to a charging device for executing a predetermined charging process for one or more portions of the content;
a charge requesting unit configured to sending a payment request for a selected section to the charging device, and receiving permission to obtain a selected section from the charging device in accordance with the request; and
a playback/output unit configured to playing back/outputting the selected section based on the permission received by the charge requesting unit.

7. A content receiving method, comprising the steps of:
(a) receiving content having a plurality of sections, and charge information corresponding to the content;
(b) calculating the cost of each of the plurality of sections based on the charge information received in step (a);
(c) associating the cost of each section calculated in step (b) with each section and outputting the same; and
(d) receiving a selection of at least one section.

8. A content receiving program for enabling a computer to function as:
a receiving unit configured to receiving content having a plurality of sections, and charge information corresponding to the content;
a calculating unit configured to calculating the cost of each of the plurality of sections based on the charge information received by the receiving unit;
an output unit configured to associating the cost of each section calculated by the calculating unit with each section and outputting the same; and
a selection receiving unit configured to receiving a selection of at least one section.

9. A content receiving apparatus, comprising:
a receiving unit configured to receiving content having a plurality of sections, and charge information corresponding to each section of the content;
an output unit configured to associating the cost of each section received by the receiving unit with each section and outputting the same; and
a selection receiving unit configured to receiving a selection of at least one section.
